(19) United States
(12) Patent Application Publication
(10) Pub. No.: US 2008/0244099 A1
(43) Pub. Date: Oct. 2, 2008

(54) Data Transfer Control System

(76) Inventor: Shinobu Machida, Kyoto (JP)

Correspondence Address: MCDERMOTT WILL & EMERY LLP, 600 13TH STREET, NW, WASHINGTON, DC, 20005-3096, US

(21) Appl. No.: 10/593,643

(22) PCT Filed: Jan. 28, 2005
(86) PCT No.: PCT/JP05/01255

§ 371 Date: Sep. 21, 2006

(30) Foreign Application Priority Data
Mar. 22, 2004 (JP) 2004-083373

(51) Int. Cl. G06F 13/10

(52) U.S. Cl. 710/6

(57) ABSTRACT

Process steps from the step of judging whether or not data transfer at a target has been completed to the step of transferring status information to a host are automated. When an error is generated, the generation of the error is notified to an external control unit and the external control unit which has received the notification performs proper error processing.

### TECHNICAL FIELD

The present invention relates to a data transfer control system for performing interconversion between computer and computer peripheral equipment.

### BACKGROUND ART

FIG. 9 is a block diagram illustrating a configuration of a known interface conversion system. FIG. 10 is a flow chart showing process steps for known command processing.

In FIG. 9, 41 denotes a host such as personal computer, 42 denotes a target such as computer peripheral equipment, 43 denotes an IEEE1394 bus which is a high speed serial bus, 44 denotes an IDE (integrated drive electronics) bus, 45 denotes a converter for performing protocol interconversion between the IEEE1394 bus 43 and the IDE bus 44 and 46 denotes an external control unit for controlling the converter 45. In this case, the converter 45 includes a host-addressed status transfer unit 47, a data transfer processing unit 48 and a command processing unit 49.

The host-addressed status transfer unit 47 transfers status information to the host 41 via the IEEE1394 bus 43.

The data transfer processing unit 48 performs data transfer between the host 41 and the target 42 and, furthermore, performs judgment on whether or not data transfer at the IEEE1394 bus 43 has been completed.

The command processing unit 49 performs protocol conversion of a command received from the host 41 via the IEEE1394 bus 43 and issues a command to the target 42 via the IDE bus 44. Furthermore, the command processing unit 49 issues a designated command to the target 42 according to an instruction of the external control unit 46.

To perform data transfer with the target 42, the host 41 issues an arbitrary command via the IEEE1394 bus 43 and, as shown in FIG. 10, in Step S401, the converter 45 waits until the converter 45 receives a command from the host 41 and, when a command is received, the process proceeds to Step S402.

In Step S402, when the converter 45 receives the command from the host 41, the external control unit 46 generates status information for the received command. At this time point, the status information is not written in the host-addressed status transfer unit 47. Contents of the status information prepared at this point is made on the assumption that processing of the received command has been normally completed.

In Step S403, the command processing unit 49 protocol converts the received command to obtain a suitable command to the target 42 and issues the converted command via the IDE bus 44.

In Step S404, the data transfer processing unit 48 starts transferring data between the host 41 and the target 42. Note that the data is transferred at an amount which the host 41 designates by the command, while the data transfer processing unit 48 performs protocol conversion of the IDE bus 44 and the IEEE1394 bus 43.

In Step S405, when the data transfer processing unit 48 detects completion of data transfer at the IEEE1394 bus 43, data transfer completion is notified to the external control unit 46 and subsequently the external control unit 46 detects completion of data transfer at the IDE bus 44.

After completion of data transfer at the IDE bus 44 has been detected in Step S405, the external control unit 46 judges whether the data transfer at the IDE bus 44 has been normally completed in Step S406.

In Step S406, if it is judged that data transfer has been normally completed, the process proceeds to Step S409 to transfer the status information.

In Step S406, if it is judged that data transfer is terminated with an error, the process proceeds to Step S407 and the external control unit 46 makes the command processing unit 49 issue a command for obtaining error information for an error generated at the target 42 and obtains error information.

In Step S408, the external control unit 46 rewrites the status information prepared in Step S402 so as to replace the status information with the obtained error information.

In Step S409, the external control unit 46 writes the status information prepared in Step S402 or Step S408 on the host-addressed status transfer unit 47.

In Step S410, the external control unit 46 transfers the status information to the host 41 via the IEEE1394 bus 43.

In the above-described manner, in the known interface transfer system, process steps from the step of detecting completion of data transfer at the target 42 to the step of transferring status information to a host (Step S405 through Step S410) are performed by the external control unit 46.

In Patent Reference 1, in contrast to the above-described configuration, a system for automatically processing status information is described.

### Patent Reference 1: Japanese Laid-Open Publication No. 1-84472

### DISCLOSURE OF INVENTION

### Problems that the Invention is to Solve

However, in the above-described configuration, the external control unit is always involved in judgment on whether or not data transfer has been completed, judgment on whether or not data transfer has been normally completed, a write operation of status information onto the host-addressed status transfer unit and a transfer operation of status information to a host. Thus, even in the case where existing status information is transferred when data transfer is normally completed, the above-described process steps are performed at a target and it requires time to perform the above-described process steps. This has prevented improvement of data transfer efficiency of a whole system.

Moreover, when the above-described process steps are all automatically performed, the process steps have to be adjusted so as to support any kind of situations which possibly occur at the target. Depending on systems, there could be various kinds of situations. Thus, even though a system can be made so as to be capable of supporting any kind of situations, it is difficult to avoid increase in the scale of the system and increase in price.

In view of the above-described problems, the present invention has been devised and it is therefore an object of the present invention to improve data transfer efficiency in an interface conversion system for performing interconversion between different kinds of arbitrary interfaces and thus achieve high performance and flexibility in processing of an error, thereby providing a system which is capable of high-speed operation and easy to use.

### Solution to the Problems

According to the present invention, to achieve the above-described object, process steps from the step of judging whether data transfer at a target has been completed to the step of transferring status information to a host are automated and, if an error is generated, error generation is notified to an external control unit so that the external control unit which has received the notice can perform proper error processing.

Specifically, the present invention is directed to a data transfer control system including: a host including a first interface; a target including a second interface; a converter for performing interconversion between the first and second interfaces; and an external control unit for controlling the converter, the converter includes a command processing unit for issuing a command received from the host via the first interface to the target via the second interface, a data transfer processing unit for performing data transfer between the host and the target while performing interconversion between the first and second interfaces, a host-addressed status transfer unit for transferring status information generated for the received command to the host via the first interface, and a target command processing judgment unit for performing command processing judgment at the target, the target command processing unit performs an operation of detecting completion of the data transfer and judging whether or not the data transfer has been normally completed, a write operation of writing the status information on the host-addressed status transfer unit, a transfer operation of transferring the status information written on the host-addressed status transfer unit and a notifying operation of notifying a state of the target to the external control unit.

According to the present invention, the converter may perform a reexecuting operation of reexecuting, when an error is generated in command processing, the command processing according to contents of the error.

According to the present invention, the command reexecuting operation may include a reexecution number limiting operation of limiting a number of times of reexecutions.

According to the present invention, the converter may further include a switching unit for selectively switching an operation of the target command processing judgment unit to be enable or disable.

According to the present invention, the converter may issue, regardless of an instruction from the host, an arbitrary command to the target at an arbitrary timing.

### Effects of the Invention

Thus, according to the present invention, automatic control or manual control is assigned depending on the case where data transfer is normally completed and the case where data transfer is terminated with an error. Thus, when data transfer is normally completed, a command processing time is reduced, so that transfer efficiency of an entire system can be improved.

Moreover, in command processing, only little involvement of an external control unit is required and thus the external control unit can be made to perform some other processing while data transfer is performed. That is, the external control unit can be efficiently utilized.

Furthermore, when data transfer is terminated with an error, the external control unit is made to perform proper error processing. Thus, a flexible and stable system can be achieved.

Furthermore, according to the present invention, a command can be reissued according to contents of error information. Thus, error processing load on a host can be reduced. Moreover, a processing time can be reduced to be smaller than that in the case where an error generation command is reissued from a host, so that transfer efficiency of an entire system can be improved.

Furthermore, according to the present invention, deadlock can be avoided by limiting the number of times of reissuing a command.

Furthermore, according to the present invention, with a switching unit provided in a converter, automatic processing of process steps from the step of detecting completion of data transfer to the step of transferring status information can be switched to be enable or disable by the switching unit. Therefore, various systems can be flexibly supported. Accordingly, a system which is easy to use can be achieved.

Furthermore, according to the present invention, utilizing a time before a command is issued from a host, an arbitrary command which is frequently issued is issued to a target beforehand and latest status information for the target with respect to the command is fetched in advance. Thus, if the arbitrary command from the host corresponds to the command issued beforehand, the process can proceed to the step of transferring status information immediately. Accordingly, a time from reception of a command to transfer status information is largely reduced and therefore transfer efficiency of an entire system can be improved.

### BRIEF DESCRIPTION OF DRAWINGS

FIG. 1 is a block diagram of an interface converting system according to the present invention.

FIG. 2 is a flow chart showing process steps of command processing according to a first embodiment of the present invention.

FIG. 3 is a diagram showing comparison in command processing time between the present invention and a known technique.

FIG. 4 is a flow chart showing process steps of command processing according to a second embodiment of the present invention.

FIG. 5 is a diagram showing comparison in command processing time for the second embodiment of the present invention.

FIG. 6 is a block diagram of an interface converting system according to a third embodiment of the present invention.

FIG. 7 is a flow chart showing process steps of command processing according to a fourth embodiment of the present invention.

FIG. 8 is a diagram showing comparison in command processing time for the fourth embodiment of the present invention.

FIG. 9 is a block diagram of a known interface converting system.

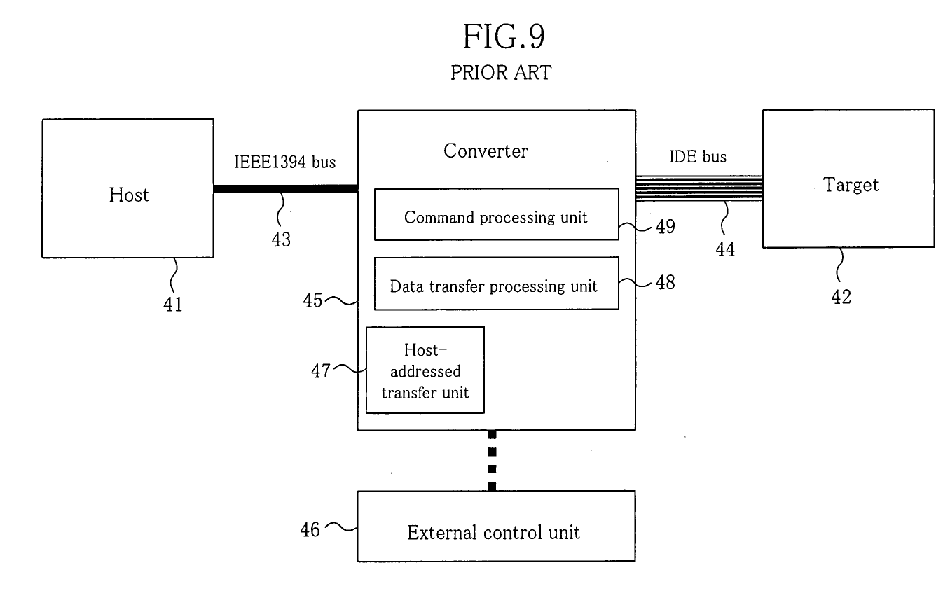

FIG. 10 is a flow chart showing process steps of known command processing.

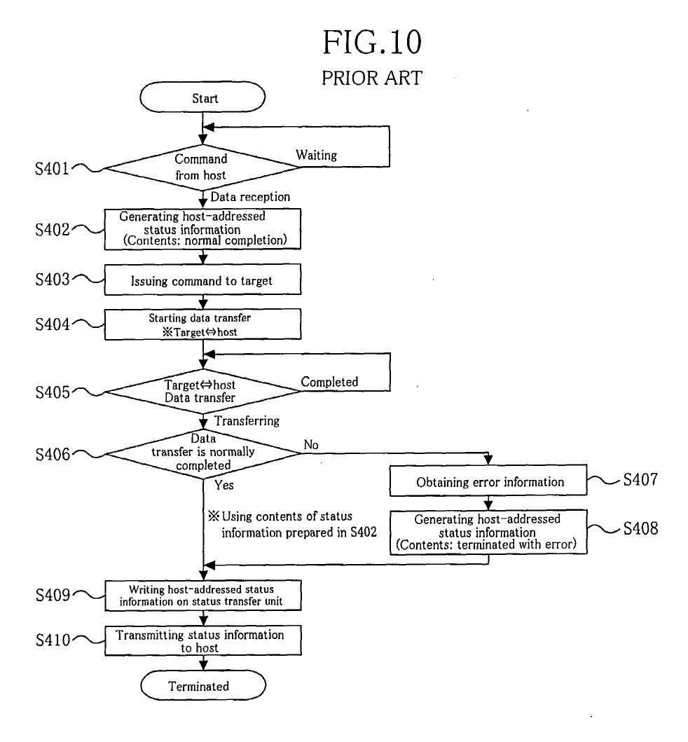

### EXPLANATION OF REFERENCE NUMERALS

1. Host
2. Target
3. IEE1394 bus
4. IDE bus
5. Converter
6. External control unit
7. Host-addressed status transfer unit
8. Data transfer processing unit
9. Command processing unit
10. Target command processing judgment unit
31. Switching unit

### BEST MODE FOR CARRYING OUT THE INVENTION

Hereafter, embodiments of the present invention will be described with reference to the accompanying drawings. Basically, preferred embodiments below will be described only for the purpose of illustrating examples and it is not intended to limit the present invention, its application object or its application to those examples.

### First Embodiment

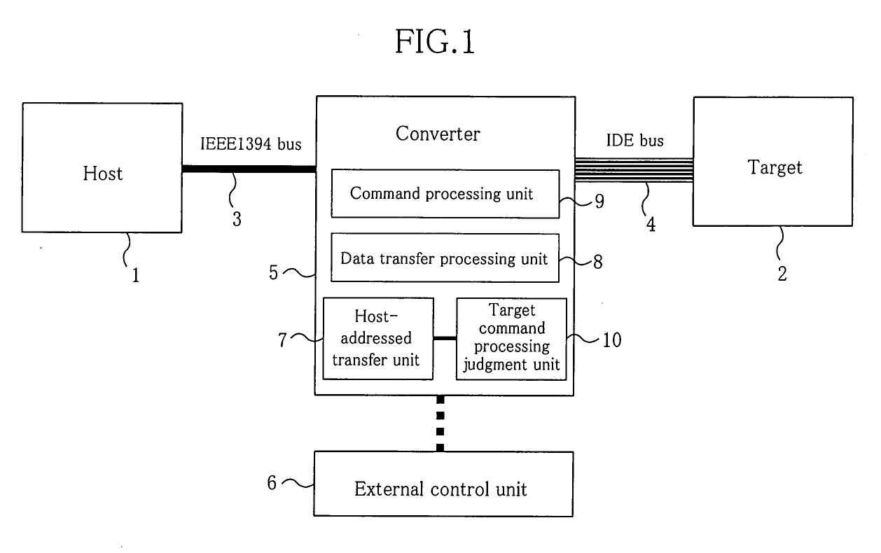

FIG. 1 is a block diagram illustrating an interface converting system according to a first embodiment of the present invention. In FIG. 1, 1 denotes a host such as personal computer, 2 denotes a target such as computer peripheral equipment (e.g., DVD-ROM/RAM, CD-ROM drive and the like), 3 denotes an IEEE1394 bus which is a high speed serial bus, 4 denotes an IDE bus, 5 denotes a converter for performing protocol interconversion between the IEEE1394 bus 3 and the IDE bus 4 and 6 denotes an external control unit such as microcomputer for controlling the converter 5.

The converter 5 includes a host-addressed status transfer unit 7 for transferring status information to the host 1 via the IEEE1394 bus 3, a data transfer processing unit 8 for performing data transfer between the host 1 and the target 2, a command processing unit 9 for issuing a command issued from the host 1 to the target 2 and furthermore issuing a designated command to the target 2 according to an instruction of the external control unit 6 and a target command processing judgment unit 10 for performing command processing judgment at the target.

The target command processing judgment unit 10 detects completion of data transfer at the target 2, judges which data transfer has been normally completed or terminated with an error, writes status information on the host-addressed status transfer unit 7 and transfers the status information from the host-addressed status transfer unit 7 to the host 1. Furthermore, the target command processing judgment unit 10 notifies error generation to the external control unit 6.

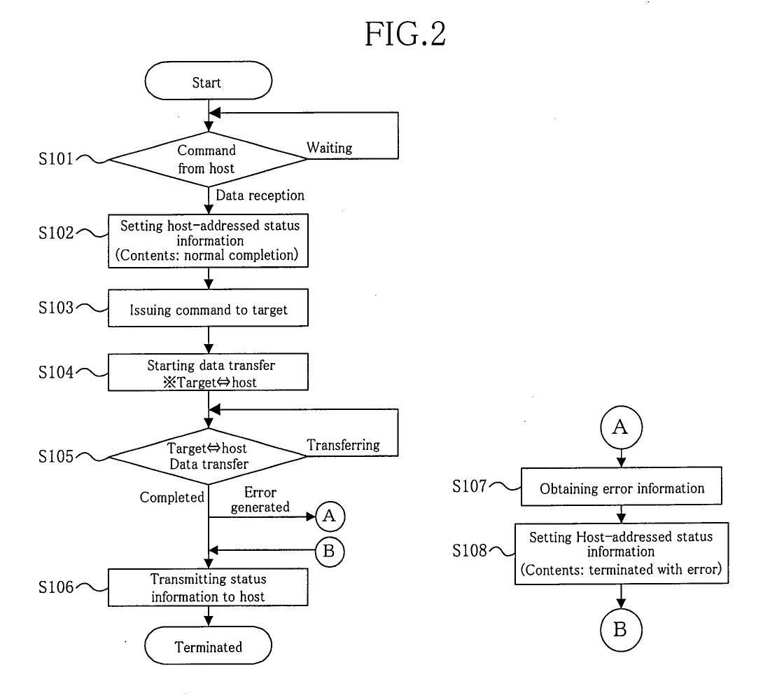

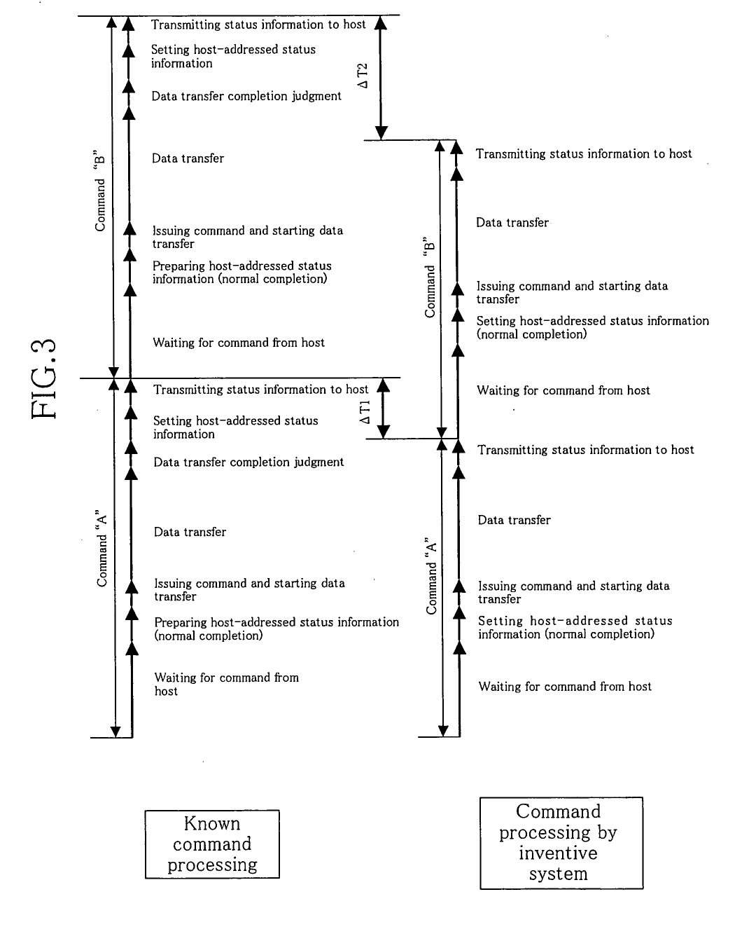

FIG. 2 is a flow chart showing process steps of command processing according to the present invention. FIG. 3 is a diagram showing comparison in command processing time for the present invention.

To perform data transfer with the target 2, the host 1 issues an arbitrary command via the IEEE1394 bus 3. As shown in FIG. 2, in Step S101, the converter 5 waits until it receives a command from the host 1 and when a command is received, the process proceeds to Step S102.

In Step S102, when the converter 5 receives a command from the host 1, the target command processing judgment unit 10 writes status information for the received command on the host-addressed status transfer unit 7. Contents of the status information written in this process step are determined on the assumption that the processing of the received command has been normally completed.

In Step S103, the command processing unit 9 performs protocol conversion to the received command so that the received command becomes suitable for the target 2 and issues the converted command via the IDE bus 4.

In Step S104, the data transfer processing unit 8 starts transferring data between the host 1 and the target 2. Note that the data is transferred at an amount which the host 1 designates by the command, while the data transfer processing unit 8 performs protocol conversion of the IDE bus 4 and the IEEE 1394 bus 3.

In Step S105, when the target command processing judgment unit 10 detects completion of data transfer between the host 1 and the target 2, the target command processing judgment unit 10 automatically judges which data transfer at the target 2 has been normally completed or terminated with an error.

If it is judged that the data transfer has been normally completed, the process proceeds to Step S106 and, to transfer the status information which has been written beforehand in Step S102 to the host 1, the host-addressed status transfer unit 7 is made to transfer the status information. Note that the status information is transferred to the host 1 via the IEEE1394 bus 3.

As has been described, since the external control unit 6 is not involved in data transfer, in view of the host 1, a time from issuing of a command to reception of status information is reduced, compared to the known technique. Thus, a command issuing interval can be reduced as a whole, resulting in improvement of data transfer efficiency.

If data transfer at the target 2 has been terminated with an error, error generation is notified to the external control unit 6 and the external control unit 6 is made to perform processing for the error. Note that as a method for notifying an error, a resister is provided in the converter 5 and information may be stored in the resister to notify the error. As another method, the generation of the error may be notified to the external control unit 6 by interruption. This is for making it possible to notify error generation to the external control unit 6 quickly and preferentially and, furthermore, avoiding placing any other load than necessary load (error generation) on the external control unit 6.

In Step S107, the external control unit 6 which has received an error notification obtains error information for the error generated at the target 2. Specifically, the external control unit 6 instructs the command processing unit 9 to issue a designated command for obtaining error information and issues the designated command to the target 2 via the IDE bus 4, thereby obtaining error information.

In Step S108, the error information is written in the host-addressed status transfer unit 7 in the converter 5. By this process step, the status information which has been written beforehand in Step S102 to indicate “normal completion” is rewritten as “error information”.

In Step S106, the status information is transferred to the host 1 via the IEEE1394 bus 3.

As has been described, when an error is generated, control is performed so as to have the external control unit 6 involved and perform proper error processing. Thus, because of the involvement of the external control unit 6, data transfer efficiency in the entire system is reduced. However, this leads particularly good results. That is, error processing can be reliably done and stability of the entire system can be achieved.

As the host 1 receives the status information from the target 2, the host 1 judges that a series of processing for an issued command has been completed and then determines which to issue a next command on the basis of the status information which has been returned or the same command again. This processing depends on the host 1 and has nothing to do with the system. As a process step of this system, the process returns to Step S101 and waits for a next command.

As shown in FIG. 3, in comparison between known command processing and command processing by the system according to the present invention, a processing time is reduced by ΔT1 at a time of command “A” completion and by ΔT2 at a time of command “B” completion in the system of the present invention.

As has been described, according to the first embodiment, automatic control or manual control is assigned depending on the case where data transfer is normally completed and the case where data transfer is terminated with an error. Thus, when data transfer is normally completed, a command processing time is reduced, so that transfer efficiency of an entire system can be improved.

Moreover, in command processing, only little involvement of an external control unit is required and thus the external control unit can be made to perform some other processing while data transfer is performed. That is, the external control unit can be efficiently utilized.

Furthermore, when data transfer is terminated with an error, the external control unit is made to perform proper error processing. Thus, a flexible and stable system can be achieved.

### Second Embodiment

Next, a second embodiment of the present invention will be described. Note that a configuration of an interface converting system and a processing flow according to the second embodiment are basically the same as those in the first embodiment. Therefore, each member also described in the first embodiment is identified by the same reference numeral and only differences will be described.

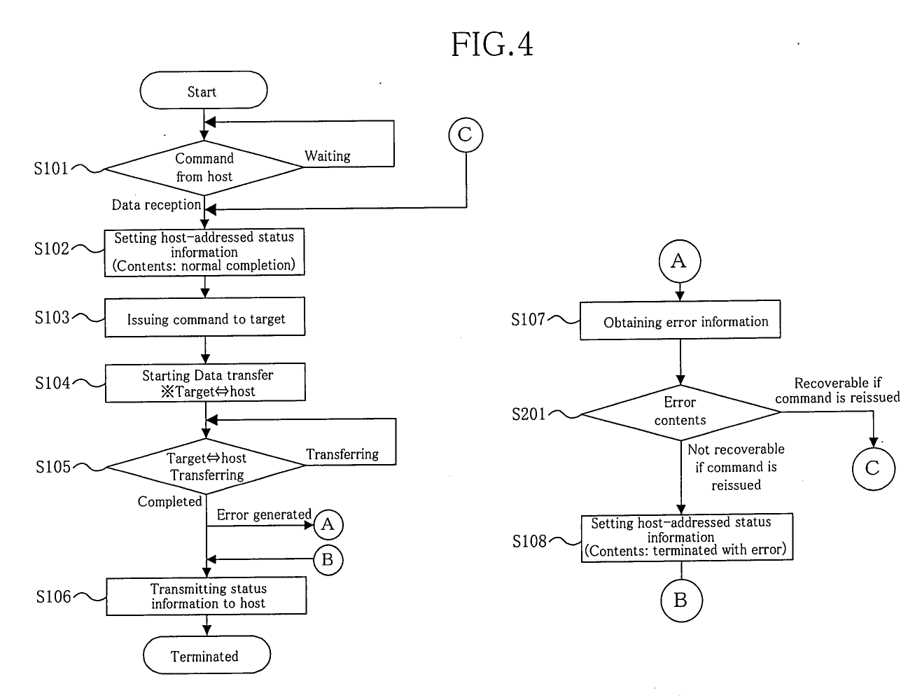

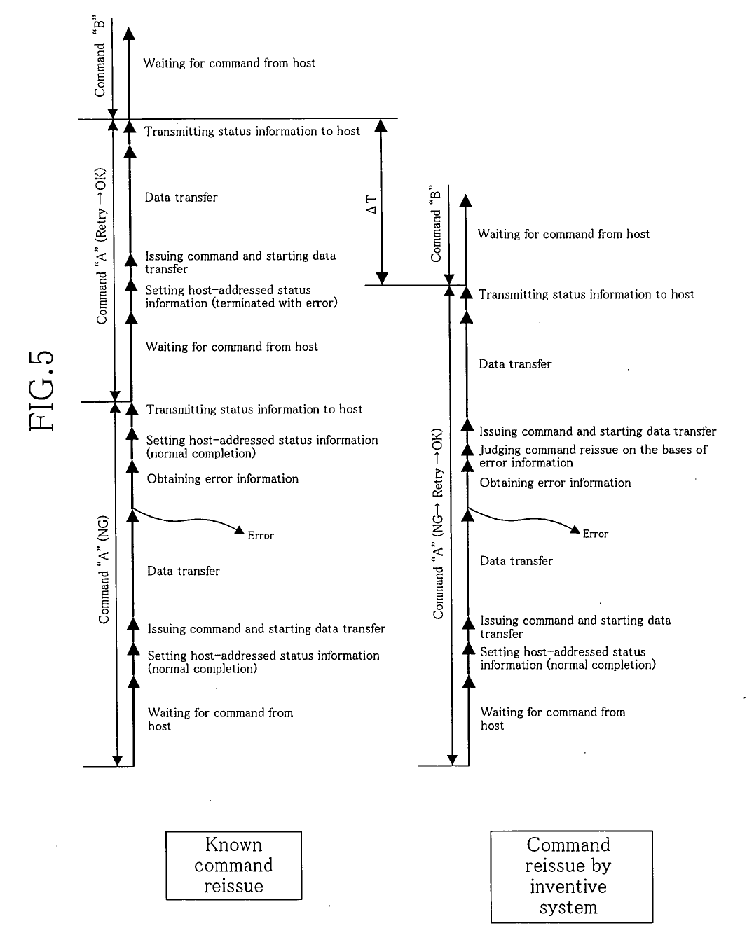

FIG. 4 is a flow chart showing process steps of command processing according to this embodiment. FIG. 5 is a diagram showing comparison in command processing time for the present invention.

In FIG. 4, when data transfer between a host 1 and a target 2 is completed and an error is generated at a target 2, a target command processing judgment unit 10 notifies error generation to an external control unit 6.

In Step S107, the external control unit 6 which has received an error notification receives error information for the error generated at the target 2.

In Step S201, the external control unit 6 judges contents of the obtained error information. If the contents of the error include only garbled data and missing data, the error is assumed to be an inconvenience temporarily caused by an external factor in an IDE bus 4. Therefore, it is judged that no critical error is not generated at the target 2 and the error can be recovered by reissuing a command and the process returns to Step S102 to reissue a command to the target 2 via the IDE bus 4. At this time, status information has not been transferred to the host 1 and therefore a next command from the host 1 is not received. That is, a command processing unit 9 is in a state where the command at a time of the error generation can be immediately reissued.

Then, when processing of a reissued command is normally completed, status information indicating normal completion is transferred to the host 1. This is because when the process shifts to command reissuing processing, the status information indicating normal completion has been already written in a host-addressed status transfer unit 7 in Step S102. Thus, the host 1 judges that an issued command has been completed and can be shifted to a next command processing.

In other cases than the above-described case, it is judged that the error can not be recovered. Then, in Step S108, the status information (an error in this case) obtained from the target 2 in the known manner is written in the host-addressed status transfer unit 7, in Step S106, the status information is transferred to the host 1 via an IEEE1394 bus 3 and a series of command processing is completed.

Note that the number of times for reissuing a command may be limited and, after error recovery processing has been performed for a specific number of times, it may be judged that an error can not be recovered and status information (error) may be transferred to the host 1 in the same manner as in the case of a normal error. Thus, an infinite loop of error recovery processing can be avoided.

As shown in FIG. 5, in comparison between known command reissue processing and command reissue processing by the system according to the present invention, a processing time is reduced by ΔT before command processing is normally completed in the system of the present invention.

As has been described, according to the second embodiment, a command can be reissued according to contents of error information. Thus, error processing load on a host can be reduced.

Moreover, a processing time can be reduced to be smaller than that in the case where an error generation command is reissued from a host, so that transfer efficiency of an entire system can be improved.

Furthermore, according to the present invention, deadlock in the system can be avoided by limiting the number of times of reissuing a command.

### Third Embodiment

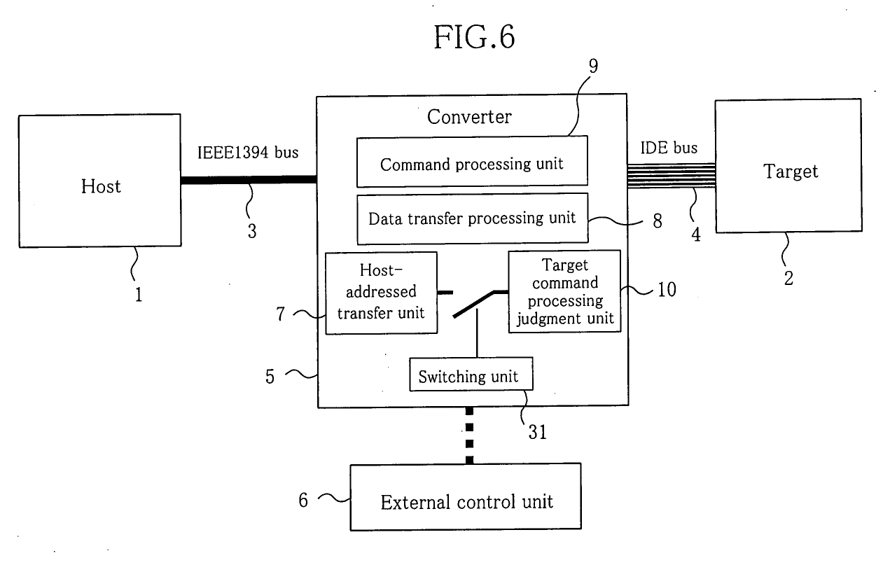

Furthermore, a third embodiment of the present invention will be described. FIG. 6 is a block diagram of an interface converting system according to the third embodiment.

As shown in FIG. 6, a configuration of the interface converting system according to the third embodiment is obtained by adding a switching unit 31 for selectively switching the function of a target command processing judgment unit 10 to an enable state or a disable state to the interface converting system of the first embodiment.

In this case, the switching unit 31 switches the function of the target command processing judgment unit 10 to an enable state or a disable state, on the basis of a preset value set in a resister provided in a converter 5 or an input value received from input equipment externally connected to the converter 5.

When the target command processing judgment unit 10 is set to be an enable state by the switching unit 31, a configuration where the target command processing judgment unit 10 and a host-addressed status transfer unit 7 are connected to each other is obtained. Accordingly, the control described in the first embodiment is performed.

When the target command processing judgment unit 10 is set to be a disable state by the switching unit 31, a configuration where the target command processing judgment unit 10 and the host-addressed status transfer unit 7 are freed up is obtained. Accordingly, the external control unit 6 is made to perform a series of processing, i.e., detection of completion of data transfer at a target 2, judgment on which the data transfer has been normally completed or terminated with an error, a write operation of status information to the host-addressed status transfer unit 7 and a transfer operation of status information from the host-addressed status transfer unit 7 to the host 1.

As has been described, according to the third embodiment, with a switching unit provided in a converter, automatic processing of process steps from the step of detecting completion of data transfer to the step of transferring status information can be switched to be enable or disable. Thus, various systems can be flexibly supported. Therefore, a system which is easy to use can be achieved.

For example, even when data transfer has been normally completed, arbitrary information can be added to status information. Moreover, this embodiment is applicable to the case where other processing is required before transferring status information and automatic transfer of status information is not desired.

### Fourth Embodiment

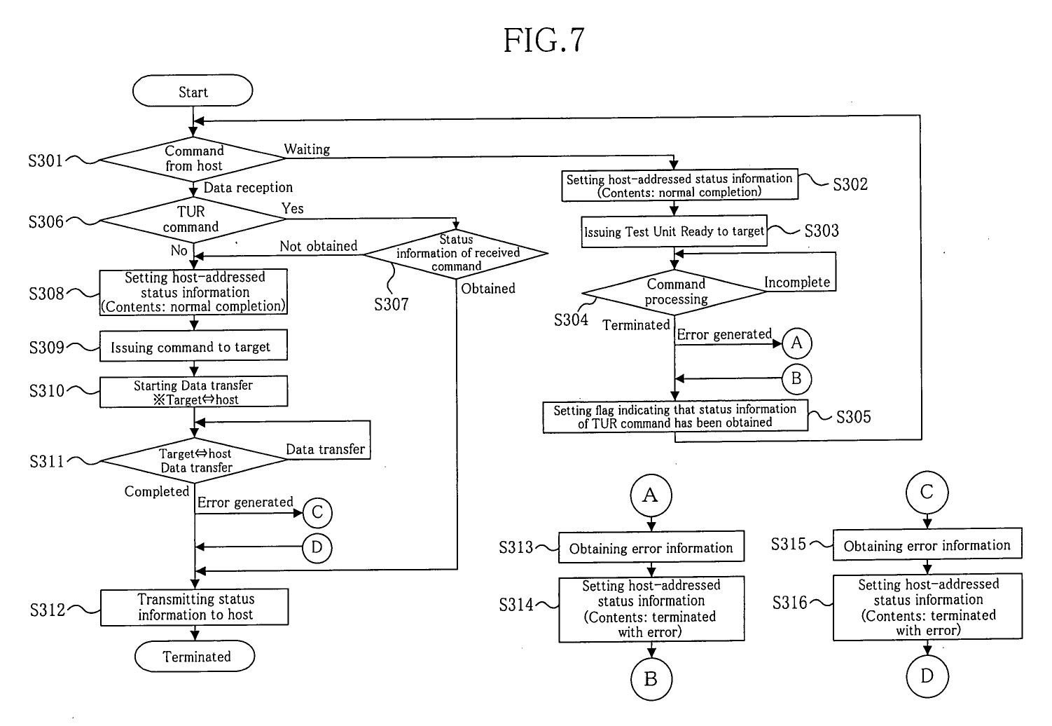

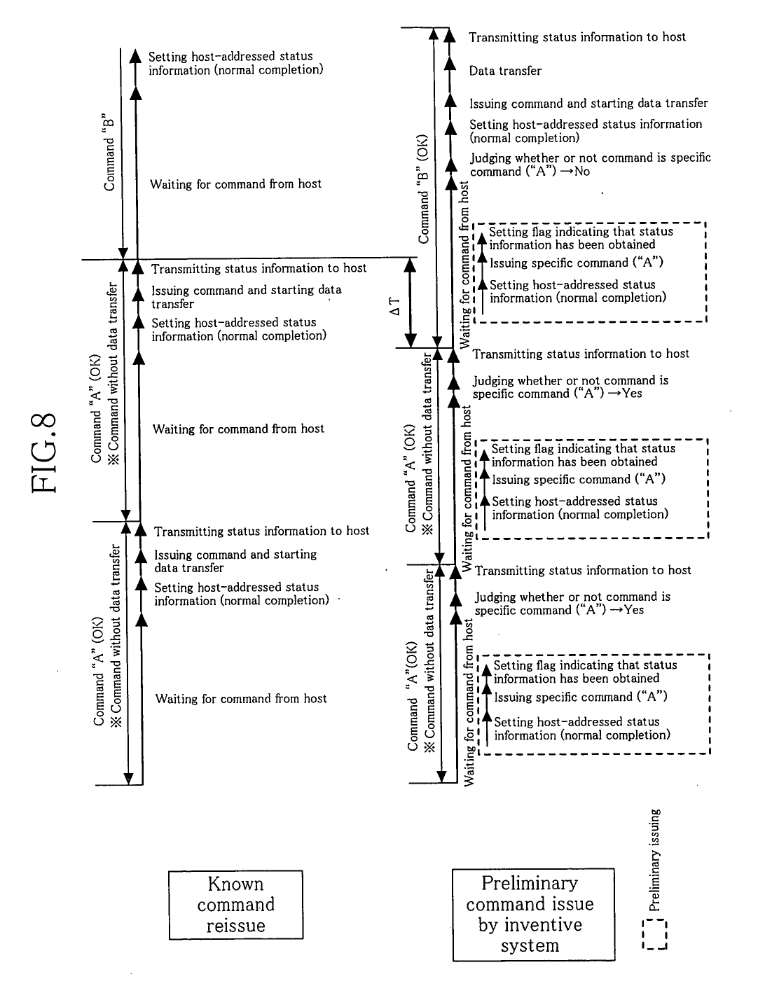

A fourth embodiment of the present invention will be described. FIG. 7 is a flow chart showing process steps of command processing according to the fourth embodiment. FIG. 8 is a diagram showing comparison in command processing time.

To perform data transfer with a target 2, a host 1 issues an arbitrary command via an IEEE1394 bus 3. As shown in FIG. 7, in Step S301, a converter 5 waits until the converter 5 receives a command from the host 1 and the process proceeds to Step S302. When a command is received in Step S301, the process proceeds to Step S306.

In Step S302, status information on the assumption that command processing has been normally completed is set, and the process proceeds to Step S303.

In Step S303, an external control unit 6 makes a command processing unit 9 issue a “Test Unit Ready command (which will be hereafter referred to as a TUR)” which is frequently issued from the host 1 and can be processed in a short time without performing data transfer. The TUR command is treated in the same manner as command processing which is usually performed between the host 1 and the target 2.

In Step S304, when a target command processing judgment unit 10 detects completion of TUR command processing, the target command processing judgment unit 10 automatically judges which data transfer at the target 2 has been normally completed or terminated with an error.

If it is judged that the command processing has been normally completed, the process proceeds to Step S305 and stores information indicating that status information has been obtained in a flag which has been prepared beforehand to indicate that status information for the TUR command has been obtained. Then, the process returns to Step S301.

If it is judged that the command processing has been terminated with an error, the process proceeds to Step S313 and, in Step S313, the external control unit 6 which has received error notification obtains error information for an error generated at the target 2.

In Step S314, the error information is written in a host-addressed status transfer unit 7 in a converter 5. Then, the process proceeds to Step S305.

The TUR command processing (Step S301 through Step S305) which has been described are repeated by the external control unit 6 and the converter 5 until a command is received from the host 1.

Now, a correlation between command processing issued by the host 1 and preliminary command issue processing utilizing a waiting time for receiving a command from the host 1 is shown in lower part of FIG. 8. With this correlation, the converter 5 obtains latest status information for the TUR command at any time and becomes in a state where it can immediately transfer the latest status information.

Next, when a command from the host 1 is received, whether or not the received command is a TUR command is judged in Step S306.

If a judgment result in Step S306 is “YES”, the process proceeds to Step S307 and whether the received command has obtained latest status information for the TUR command is judged using the flag set in Step S305.

If a judgment result in Step S307 is “Obtained”, the process proceeds to Step S312 and status information is immediately transferred to the host 1. Note that in Step S302 or Step S314, setting of the latest status information for the TUR command has been completed and data transfer may be immediately performed.

If a judgment result in Step S307 is “Not Obtained” (a command issued from the host 1 is anything but a TUR or status information for a TUR command has not been obtained), normal processing (Step S308→Step S309→Step S310→Step S311→Step S312 or Step S308→Step S309→Step S310→Step S311→Step S315→Step S316→Step S312) is performed as in the first embodiment.

Note that in the fourth embodiment, the description has been made with a command issued to the target 2 during a waiting time for a command from the host 1 assumed to be a TUR command but the command issued to the target 2 is not limited thereto. The command issued to the target 2 may be selected according to a system.

As shown in FIG. 8, in comparison between the known command processing and the command processing by the system according to the present invention, a processing time ΔT is reduced before data processing is normally completed in the system of the present invention.

As has been described, according to the fourth embodiment, utilizing a time before a command is issued from a host, an arbitrary command which is frequently issued is issued to a target beforehand and latest status information for the target with respect to the command is fetched in advance. Thus, if the arbitrary command from the host corresponds to the command issued beforehand, the process can proceed to the step of transferring status information immediately. Accordingly, a time from reception of a command to transfer status information is largely reduced and therefore transfer efficiency of an entire system can be improved.

### INDUSTRIAL APPLICABILITY

As has been described, according to the present invention, in computer peripheral equipment or the like including an IEEE1394 which is a high-speed serial bus, a USB, an IDE interface or the like, a command processing time can be reduced and transfer efficiency of an entire system can be improved. That is, the present invention has highly practical effects. Therefore, the present invention is useful as a bridge system for realizing high-speed data transfer.

1. A data transfer control system comprising:
a host including a first interface;
a target including a second interface;
a converter for performing interconversion between the first and second interfaces; and
an external control unit for controlling the converter,
wherein the converter includes
a command processing unit for issuing a command received from the host via the first interface to the target via the second interface,
a data transfer processing unit for performing data transfer between the host and the target while performing interconversion between the first and second interfaces,
a host-addressed status transfer unit for transferring status information generated for the received command to the host via the first interface, and
a target command processing judgment unit for performing command processing judgment at the target,
wherein the target command processing unit performs an operation of detecting completion of the data transfer and judging whether or not the data transfer has been normally completed, a write operation of writing the status information on the host-addressed status transfer unit, a transfer operation of transferring the status information written on the host-addressed status transfer unit and a notifying operation of notifying a state of the target to the external control unit.

2. The data transfer control system of claim 1, wherein the converter performs a reexecuting operation of reexecuting, when an error is generated in command processing, the command processing according to contents of the error.

3. The data transfer control system of claim 2, wherein the command reexecuting operation includes a reexecution number limiting operation of limiting a number of times of reexecutions.

4. The data transfer control system of claim 1, wherein the converter further includes a switching unit for selectively switching an operation of the target command processing judgment unit to be enable or disable.

5. The data transfer control system of claim 1, wherein the converter issues, regardless of an instruction from the host, an arbitrary command to the target at an arbitrary timing.
